(19) United States
(12) Patent Application Publication
(10) Pub. No.: US 2026/0348534 A1
(43) Pub. Date: Nov. 5, 2026

(54) Holding Element for Holding One or More Electrical Energy Accumulators, and Pressure Vessel System

(71) Applicant: Bayerische Motoren Werke Aktiengesellschaft, Muenchen (DE)

(72) Inventors: Axel RUECKER, Berg (DE); Kilian STENGEL, Muennerstadt (DE)

(21) Appl. No.: 19/488,115

(22) PCT Filed: May 6, 2024
(86) PCT No.: PCT/DE2024/100411

§ 371 Date: Nov. 26, 2025

(30) Foreign Application Priority Data
Jun. 12, 2023 (DE) 10 2023 115 223.8

(51) Int. Cl. F17C 13/08

(52) U.S. Cl. CPC F17C 13/084; F17C 2201/0104; F17C 2205/0153; F17C 2221/012; F17C 2221/033; F17C 2223/0123; F17C 2223/036; F17C 2227/0341; F17C 2270/0168

(57) ABSTRACT

A holding element for holding one or more electrical energy accumulators between two pressure vessels, wherein an elongate bore is provided for receiving one or more electrical energy accumulators and two contact faces are provided for contact with the pressure vessels.

### BACKGROUND AND SUMMARY

The technology disclosed herein relates to a holding element for holding one or a plurality of electrical energy accumulators between a first pressure vessel and a second pressure vessel. The technology disclosed herein furthermore relates to a pressure vessel system having such a holding element.

Pressure vessels are typically used for storing gaseous fuel, such as hydrogen or natural gas, for example. They can be used in particular in motor vehicles or in other mobile units, or else in stationary units. The gaseous fuel can be used, for example, to operate a fuel cell or a gas-powered internal combustion engine. It is becoming increasingly desirable to install pressure vessels not only in large vehicles in which there is typically sufficient space, but also to equip small vehicles which have potentially predefined and non-typical installation spaces, for example in an underbody area, with pressure vessels. In this context, it is typically also necessary to provide, in addition to the pressure vessels, one or a plurality of electrical energy accumulators for temporarily storing electrical energy. This can ensure, for example, that a fuel cell can be operated at an optimal operating point, or electrical energy can be kept available for emergency operation. In electrical energy accumulators of this type it is also desirable to accommodate them in an ideally space-efficient manner in installation spaces.

It is a preferred object of the technology disclosed herein to minimize or to alleviate at least one disadvantage of an already known solution or to propose an alternative solution. It is in particular a preferred object of the technology disclosed herein to provide a holding element by way of which electrical energy accumulators can be disposed in a particularly space-saving manner between pressure vessels. Further preferred objects can be derived from the advantageous effects of the technology disclosed herein.

The technology described herein relates to a holding element for holding one or a plurality of electrical energy accumulators between a first pressure vessel and a second pressure vessel, comprising (i) an elongate bore for receiving one or a plurality of electrical energy accumulators, (ii) a first contact face for resting on the first pressure vessel, and (iii) a second contact face for resting on the second pressure vessel, wherein the first contact face and the second contact face are expediently embodied to be curved.

By way of such a holding element it is advantageously possible to dispose one or a plurality of electrical energy accumulators between pressure vessels, specifically in particular in an installation space which would otherwise remain vacant if pressure vessels with a round cross section are lined up next to one another. This installation space can be ideally used because the contact faces can rest on the pressure vessels and thus ensure simple and effective mounting of the electrical energy accumulators. In this context, the contact faces can be in particular designed to complement the pressure vessels.

A holding element is understood to mean an element which can hold the electrical energy accumulator(s) in a defined location relationship relative to the pressure vessels. Said holding element can in particular be suitable for use in an intermediate space which is anyway created when two pressure vessels with a circular cross section are disposed directly adjacent to one another. The elongate bore can in particular be of a rectilinear design. The electrical energy accumulators can in particular be designed to complement the bore in such a way that they can be received in the elongate bore so as to preferably utilize the space as far as possible. The contact faces can in particular be designed with a cross section that is constant when viewed along a longitudinal extent, or along the elongate bore, respectively.

The holding element is designed to interact with electrical energy accumulators and pressure vessels. However, the electrical energy accumulators and pressure vessels are to be understood as elements that are separate from the holding element.

In particular, the first contact face and/or the second contact face can be covered with an elastically deformable layer. Such an elastically deformable layer ensures in particular that easier adaptation to pressure vessels is effected. In particular, the elastically deformable layer can also compensate for any potential expansion and/or contraction of a pressure vessel, for example due to filling or retrieving or a change in temperature.

The bore can in particular have a circular cross section. The circular cross section can in particular extend transversely to a longitudinal extent of the bore. The longitudinal extent of the bore can in particular be identical to a longitudinal extent of the holding element. For example, the holding element, when viewed along the longitudinal extent, can have a substantially constant, or else completely constant, cross section.

The bore can in particular extend parallel to a longitudinal extent of the first contact face and/or to a longitudinal extent of the second contact face. A contact face can in particular have a constant cross section along a respective longitudinal extent. This can apply, for example, to a surface of the already mentioned elastically deformable layer in a relaxed state. This can also apply to a fixed part of the holding element, or of the respective contact face.

In particular, the holding element can be embodied as an elongate profile. This permits a simple use between two pressure vessels which are typically likewise embodied to be elongate. Moreover, this enables simple production. The first contact face and/or the second contact face can preferably have a cross section in the shape of a segment of a circle. This permits easy contact on pressure vessels which typically have a circular external surface. In principle however, other cross sections are also possible so that it is possible to adapt to specific pressure vessels. For example, the holding element can also be used between pressure vessels which do not have a circular external cross section but rather have flat opposite external surfaces between which round portions are located.

According to one embodiment, one or a plurality of cooling ducts are formed in the holding element. Cooling ducts of this type can be used in order to direct a cooling fluid, for example a cooling liquid, through the holding element. As a result, the electrical energy accumulators can be cooled in a targeted manner so that overheating can be prevented and they can be operated in an ideal temperature range.

In particular, the cooling ducts can extend parallel to the bore. This permits a simple construction and conveying along the longitudinal extent of the holding element.

According to an advantageous embodiment, the holding element has a degassing groove on an external side, wherein the degassing groove is connected to the bore by way of one or a plurality of openings. The degassing groove can in particular ensure that, in the event of a thermal event, hot gases that are potentially created can be discharged to the outside and thus propagation of a thermal event across a plurality of electrical energy accumulators is avoided. The degassing groove can in particular be formed on a lateral face of the holding element that faces away from the first contact face and the second contact face. For example, the first contact face, the second contact face and the lateral face facing away therefrom can be disposed along an isosceles triangle, in particular apart from the fact that the contact faces are curved. This enables a simple embodiment and discharging of potential hot gases away from the electrical energy accumulators and the pressure vessels.

The technology disclosed herein furthermore relates to a pressure vessel system comprising (i) a plurality of pressure vessels, (ii) at least one holding element as described herein, and (iii) one or a plurality of electrical energy accumulators, wherein each holding element is disposed between in each case two pressure vessels in such a way that the contact faces of the holding element rest on in each case a pressure vessel, and wherein the electrical energy accumulators are disposed in the elongate bore of a holding element. Integrating electrical energy accumulators into intermediate spaces, suitable therefor, between pressure vessels in an installation space can take place easily by way of such a pressure vessel system. This permits the best possible utilization of available space, both pressure vessels as well as electrical energy accumulators being able to be included. In terms of the holding element, reference can be made to all embodiments and variants described herein. The contact faces can in particular be designed to complement the pressure vessels used. This permits contact which is planar and thus particularly space-saving and secure.

In particular, one holding element can in each case be disposed between all directly adjacent pairs of pressure vessels, in the elongate bore of which one or a plurality of electrical energy accumulators are located. As a result, all suitable installation spaces can be utilized in order to suitably accommodate electrical energy accumulators by way of the holding element.

It can be provided that exactly one holding element is in each case disposed between all directly adjacent pairs of pressure vessels. However, it can also be provided that two holding elements are disposed, wherein typically one holding element is disposed at the top and one holding element disposed at the bottom if the pressure vessels are horizontally adjacent. Each holding element can receive electrical energy accumulators in a bore.

The pressure vessel system can have a housing that encloses the pressure vessels and the holding elements. Such a housing can ensure an external closure and, for example, protection against mechanical damage, shocks and/or potentially penetrating dirt or liquids. The safety and stability of the pressure vessel systems can be enhanced as a result. The holding elements can in particular be fastened to the housing. The stability overall can be further enhanced as a result.

In particular, at least one degassing groove which is connected to a bore of the holding element by way of openings in a holding element can be formed in the housing. As a result, a direct discharge of hot gases, which are potentially created and can be created for example in a thermal event in an electrical energy accumulator, to the outside can be achieved. Any damage to further electrical energy accumulators or to pressure vessels is advantageously avoided as a result. The grooves in the holding element and in the housing can advantageously be in particular mutually complementary. In particular, they can be aligned flush with one another. This permits a particularly advantageous and efficient discharge of gases to the outside.

According to an advantageous embodiment, the pressure vessels are fixed transversely to their longitudinal direction by way of the holding elements. It can be in particular achieved as a result that the fastening elements perform an additional function, specifically that of fixing the pressure vessels. Additional pressure vessel fixing elements can advantageously be dispensed with as a result.

In particular, a pressure vessel system can have one or a plurality of cover plates which can in particular be fastened to the holding elements at the end faces. An ingress of dirt or liquid into the holding elements can be prevented by cover plates of this type. Moreover, the cover plates can be embodied to be larger and thus rest at locations on the pressure vessels at which said cover plates already have a smaller cross-sectional area on the end side as compared to their maximal cross-sectional area. The cover plates can also exert a pressure in the longitudinal direction on the electrical energy accumulators. Such a longitudinal direction can relate in particular to the electrical energy accumulators and/or to the pressure vessels. In order to exert a pressure of this type, the cover plates can be mutually braced in pairs, in particular by being fastened to holding elements.

Electrical energy accumulators can in particular be provided for storing electrical energy, in particular for driving at least one (traction) propulsion machine. In particular, said electrical energy accumulators can be designed as high-voltage accumulators. Electrical energy accumulators can in particular be incorporated into an onboard power system which is operated at a higher voltage level than a fuel cell system.

A pressure vessel can in particular be used to store gaseous fuel in a motor vehicle, for example a passenger car, a motorcycle or a commercial vehicle, under ambient conditions. For example, the pressure vessel system can be used in a motor vehicle which is powered by compressed natural gas (CNG) or liquefied natural gas (LNG) or by hydrogen. The pressure vessel system is typically fluidically connected to at least one energy converter which is specified to convert the chemical energy of the fuel into other forms of energy. A pressure vessel can in particular be designed as a composite overwrapped pressure vessel. For example, the pressure vessel can be a cryogenic pressure vessel or a high-pressure gas vessel. High-pressure gas vessels are designed to permanently store fuel at ambient temperatures at a nominal operating pressure (also referred to as nominal working pressure or NWP) of at least 350 barg (i.e., overpressure relative to atmospheric pressure) or at least 700 barg. A cryogenic pressure vessel is suitable to store the fuel at the aforementioned operating pressures even at temperatures which are significantly (for example more than 50 K or more than 100 K) below the operating temperature of the motor vehicle.

The pressure vessel system can also be designed as a pressure vessel assembly. The pressure vessel assembly can in particular have the pressure vessels and the further components mentioned, and furthermore have support, fastening and/or protective elements, for example protective shields, shieldings, barrier layers, covers, coatings or wrappings, which are permanently connected to the pressure vessels. The support, fastening and/or protective elements can expediently be able to be disassembled only temporarily, and preferably only by skilled personnel, and/or not in a non-destructive manner. Such a pressure vessel assembly is particularly suitable for flat installation spaces, in particular in the underfloor region below the vehicle interior. The pressure vessel assembly can preferably be able to be assembled as an entity in the installation space provided in the motor vehicle. For this purpose, the pressure vessel assembly can have common bodywork attachment points by way of which the system as an entity is able to be fastened in the motor vehicle. A pressure vessel assembly, or a pressure vessel system, preferably comprises more than three, or more than five, or more than seven, or more than ten pressure vessels.

The housing already mentioned can expediently be an encapsulation which surrounds at least the high-voltage components of the energy accumulator device. The housing can advantageously serve for protection against fire, protection against contact, protection against intrusion and/or for protection against moisture and dust. The housing can be produced, for example, at least partially from a metal, in particular from aluminum, an aluminum alloy, steel or a steel alloy. At least one or a plurality of the following components can be received in the at least one housing: accumulator cells, electrical energy accumulators, components of the power electronics system, contactor(s) for interrupting the current supply to the motor vehicle, cooling elements, electrical conductors, control apparatus(es). Expediently, the components are preassembled before assembling the assembly in the motor vehicle.

The electrical energy accumulators can in particular be designed as round cells. These can in particular be received in a cylindrical cell housing (“cell can”). If the active materials of the round cell expand due to operation-related reasons, the housing is subjected to tension in the circumferential region. Thus, comparatively thin housing cross sections can advantageously compensate for the forces resulting from the swelling. The cell housing is preferably produced from steel, or a steel alloy.

In particular, degassing openings of the electrical energy accumulators can be disposed in such a way that they point into the groove or are aligned transversely to a longitudinal extent of the groove. A degassing opening can in particular serve to allow gases that have been created to escape from the cell housing. By virtue of an arrangement pointing toward the groove, gases are first directed into the groove and can then be discharged, for example, by way of the degassing grooves mentioned.

A thermal malfunction or thermal event is regularly a malfunction in which an exothermic chemical reaction occurs. The malfunction can in particular be an event which causes non-operational and self-reinforcing production of heat in the individual cells. In this instance, propagation could set in under certain conditions. Such a malfunction can be caused, for example, by an internal short circuit in an individual cell, or by a source of fire.

In other words, it is advantageous when a cell string is fastened between pressurized hydrogen tanks or pressure vessels. Requirements pertaining to technical safety, crash behavior, acoustics, etc. typically have to be taken into account in this context. The fastening of the cell string is to guarantee that functionalities such as cooling, a degassing strategy, electrical cell string insulation and/or reliable electrical contacting can be integrated between individual cells of the cell string over the service life. The required installation space of the fastening arrangement is restricted to the vacant installation space between the pressure vessels in the energy module.

The fundamental principle of the cell string fastening described herein can be seen in using a volumetric body which is adapted to the geometry of the vacant installation space between the hydrogen accumulators or pressure vessels and extends over the entire length of the cylindrical region of the pressure vessels. For the cell string, a bore into which the selected cell format can be inserted is incorporated into this body.

The fundamental geometry of the casing for fastening the cell string corresponds to an isosceles triangle, for example, the legs of which are embodied to be circular. The legs have a radius which is adapted to the tank diameter with a corresponding oversize. Using supporting mats, this string is placed onto the hydrogen tanks or pressure vessels and is fixedly screwed to the casing of the energy module. As a result, the cell string housing also holds the pressurized hydrogen tanks or pressure vessels in the y-direction and z-direction. The fastening concept of the pressure vessels can thus be additionally simplified. There can be greater potentials for accommodating a larger quantity of hydrogen. In the x-direction, a cell string can be fixed in the housing by way of a rubber ring and a cover which is screwed to the string housing. The rubber ring is used as compensation for tolerances and clamps the battery cell string. In the y-direction and z-direction, the battery cell string can be held by the cell string housing. Additionally, each battery cell can be adhesively bonded by way of an injection bore. Alternatively, the cells can be braced by way of a clamping bar with springs and a clamping lid in the duct of the housing string. An additional recess for a degassing duct can be provided on the base of the isosceles triangle.

In particular, the fastening element can extend over the entire length of the cylindrical region of pressure vessels. An extent only partially along this length and/or an extent therebeyond are also possible. The bore can in particular extend over the entire length of the fastening element. Here too, only a partial extent of the bore is possible.

### BRIEF DESCRIPTION OF THE DRAWINGS

FIG. 1 shows a pressure vessel system,

FIG. 2 shows a holding element,

FIG. 3 shows the pressure vessel system of FIG. 1 with further components, and

FIG. 4 shows part of the pressure vessel system.

### DETAILED DESCRIPTION OF THE DRAWINGS

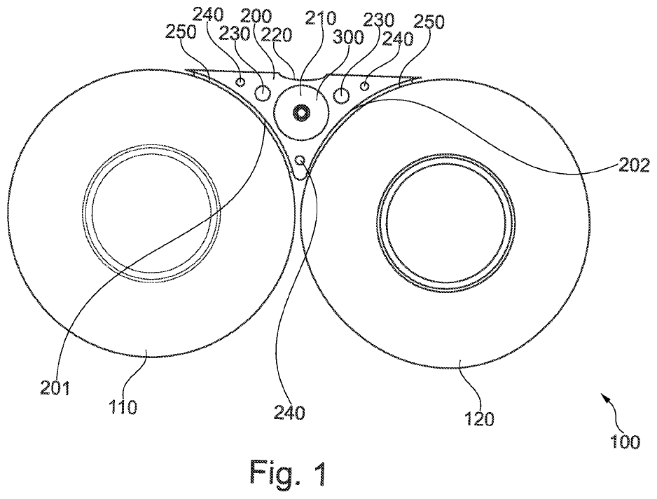

FIG. 1 purely schematically shows a pressure vessel system 100. The pressure vessel system 100 has a first pressure vessel 110 and a second pressure vessel 120 for storing gaseous fuel. A holding element 200 is disposed in an installation space which extends between the pressure vessels 110, 120 and which results on the basis of the round shape of the pressure vessels 110, 120.

The holding element 200 has a first contact face 201 and a second contact face 202. These are in each case embodied as a segment of an arc and rest in each case on a segment of one of the pressure vessels 110, 120. Thus, the first contact face 201 rests on the first pressure vessel 110. The second contact face 202 rests on the second pressure vessel 120.

Disposed on the contact faces 201, 202 are elastically deformable layers 250 which establish the contact with the pressure vessels 110, 120. Owing to this fact, it is possible to better adapt to the pressure vessels 110, 120 and by way of the elastically deformable layer 250 it is also possible to adapt in the case of a change in the external cross section of the respective pressure vessel 110, 120, for example due to a filling or retrieving procedure.

Disposed in the holding element 200, which extends transversely to the paper plane of FIG. 1, is an elongate bore 210 which also extends transversely to the paper plane of FIG. 1. Disposed therein are a plurality of electrical energy accumulators 300 which are designed as round cells. Only one of these electrical energy accumulators 300 can presently be seen. A degassing groove 220, the functionality of which will be discussed at a later stage, is located directly above the elongate bore 210. The degassing groove is formed as a notch on an upper lateral face of the holding element 200. This upper lateral face points in a direction counter to the contact faces 201, 202.

Furthermore, two cooling ducts 230 by way of which cooling fluid can be directed are disposed in the holding element 200. The electrical energy accumulators 300 can be cooled thereby. Furthermore, disposed on the end face are three threaded bores 240 which serve to fasten a cover plate to be described further hereunder.

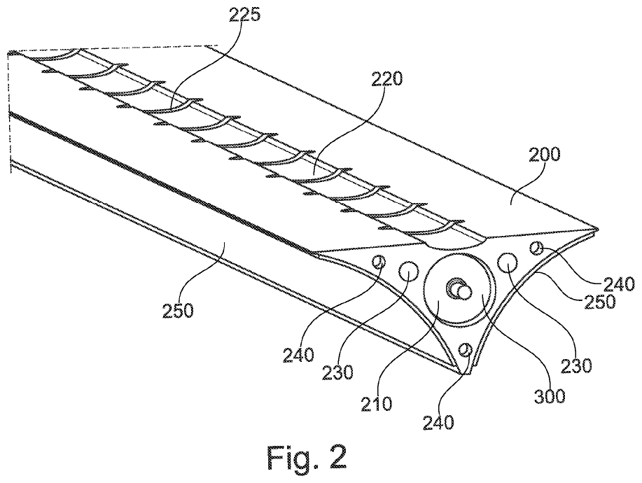

FIG. 2 shows the holding element 200 in a separate view. It can be seen here that the degassing groove 220 extends parallel to the elongate bore 210 lying directly below. A plurality of slot-shaped openings 225, which presently extend transversely to the longitudinal extent, are disposed in the degassing groove 220. Potential gas, which would escape from electrical energy accumulators 300 in the case of a thermal event, can be discharged to the outside by way of the openings 225. It can thus be prevented that the holding element 200 is damaged for example due to escaping gas of this type. Otherwise, reference is made to the description of FIG. 1.

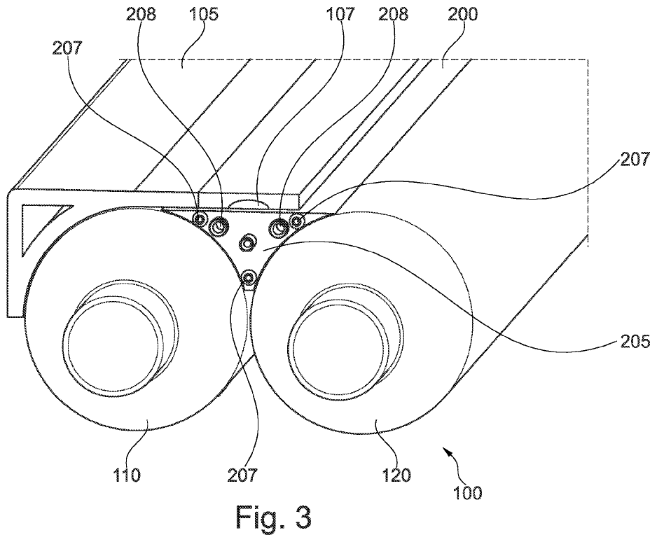

FIG. 3 shows the pressure vessel system 100 with further components, specifically with a housing 105, which is only partially illustrated here, and with a cover plate 205. The cover plate 205 is attached to the holding element 200 at the end face, specifically by way of a total of three screws 207 that engage in the threaded bores 240. The cooling ducts 230 of the holding element 200 continue in respective connecting openings 208 of the cover plate 205. A degassing groove 107 which lies directly opposite the degassing groove 220 of the holding element 200 is disposed in the housing 105. In this way, a common receptacle space for potentially escaping gas is achieved, which is formed by the two degassing grooves 107, 220. Gas can enter this receptacle space through the openings 225. The gas can then be discharged laterally along the longitudinal extent of the holding element 200. This allows potentially escaping hot gas to be guided in a controlled manner.

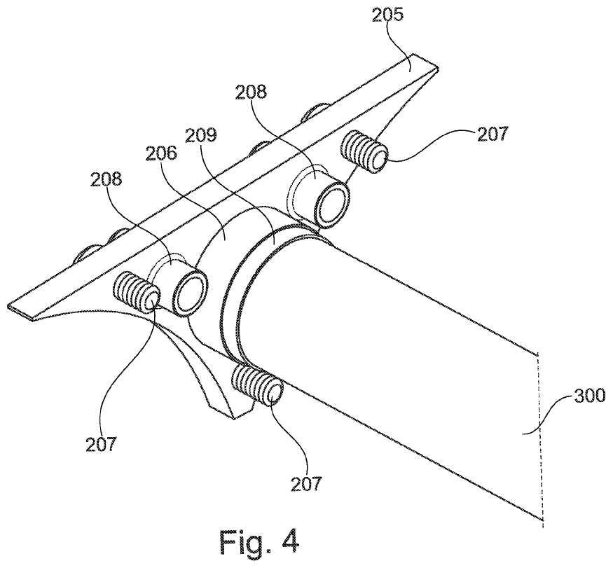

FIG. 4 shows an electrical energy accumulator 300 and, separately, a cover plate 205. The screws 207 are also illustrated. The cover plate 205 has a receptable 206 which is of round and pot-shaped design. The electrical energy accumulator 300 is introduced into this receptacle 206 and held therein. A rubber ring 209 is presently disposed between the electrical energy accumulator 300 and the cover plate 205. Said rubber ring is used for bracing and compensating for tolerances. This permits advantageous fastening and fixing of the electrical energy accumulator 300. In this way, a pressure can also in particular be exerted on a plurality of electrical energy accumulators 300 along the longitudinal direction, so that these are advantageously electrically contacted to one another. Such a pressure can in particular be exerted in that two cover plates 205, attached to opposite ends of the pressure vessel system 100, are braced onto one another in each case by way of the screws 207.

For reasons of legibility, the expression “at least one” has in some cases been omitted for simplification purposes. If a feature of the technology disclosed herein is described in the singular or in an indefinite manner (for example the/a pressure vessel, the/an energy accumulator, etc.), the plural thereof is also intended to be disclosed at the same time (for example the at least one pressure vessel, the at least one energy accumulator, etc.).

The above description of the present disclosure serves only for illustrative purposes and not for the purpose of limiting the disclosure. In the context of the disclosure, various amendments and modifications are possible without departing from the scope of the disclosure and its equivalents.

### LIST OF REFERENCE SIGNS

100 Pressure vessel system
105 Housing
107 Degassing groove
110 First pressure vessel
120 Second pressure vessel
200 Holding element
201 First contact face
202 Second contact face
205 Cover plate
206 Receptacle
207 Screws
208 Connecting openings
209 Rubber ring
210 Elongate bore
220 Degassing groove
225 Openings
230 Cooling ducts
240 Threaded bores
250 Elastically deformable layer
300 Electrical energy accumulator

1.-17. (canceled)

18. A holding element for holding one or a plurality of electrical energy accumulators between a first pressure vessel and a second pressure vessel, comprising:
an elongate bore for receiving one or a plurality of electrical energy accumulators,
a first contact face for resting on the first pressure vessel, and
a second contact face for resting on the second pressure vessel,
wherein the first contact face and the second contact face are embodied to be curved.

19. The holding element according to claim 18, wherein the first contact face and/or the second contact face are covered by an elastically deformable layer.

20. The holding element according to claim 18, wherein the bore has a circular cross section.

21. The holding element according to claim 18, wherein the bore extends parallel to a longitudinal extent of the first contact face and/or to a longitudinal extent of the second contact face.

22. The holding element according to claim 18, which is embodied as an elongate profile.

23. The holding element according to claim 18, wherein the first contact face and/or the second contact face have a cross section in the shape of a segment of a circle.

24. The holding element according to claim 18, in which one or a plurality of cooling ducts are formed.

25. The holding element according to claim 24, wherein the cooling ducts extend parallel to the bore.

26. The holding element according to claim 18, which has a degassing groove on an external side, wherein the degassing groove is connected to the bore by way of one or a plurality of openings.

27. The holding element according to claim 26, wherein the degassing groove is formed on a lateral face of the holding element that faces away from the first contact face and the second contact face.

28. A pressure vessel system comprising:
a plurality of pressure vessels,
at least one holding element according to claim 18, and
one or a plurality of electrical energy accumulators,
wherein each holding element is disposed between in each case two pressure vessels in such a way that the contact faces of the holding element rest on in each case a pressure vessel, and
wherein the electrical energy accumulators are disposed in the elongate bore of a holding element.

29. The pressure vessel system according to claim 28, wherein one holding element, in the elongate bore of which one or a plurality of electrical energy accumulators are located, is disposed in each case between all directly adjacent pairs of pressure vessels.

30. The pressure vessel system according to claim 28, which has a housing that encloses the pressure vessels and the holding elements.

31. The pressure vessel system according to claim 30, wherein the holding elements are fastened to the housing.

32. The pressure vessel system according to claim 30, wherein at least one degassing groove, which is connected to a bore of the holding element by way of openings in a holding element, is formed in the housing.

33. The pressure vessel system according to claim 28, wherein the pressure vessels are fixed transversely to their longitudinal direction by means of the holding elements.

34. The pressure vessel system according to claim 28, which has one or a plurality of cover plates which are fastened to the holding elements at the end faces.
